(19) United States
(12) Patent Application Publication
(10) Pub. No.: US 2007/0259218 A1
(43) Pub. Date: Nov. 8, 2007

(54) FUEL CELL CAPABLE OF POWER MANAGEMENT

(76) Inventors: CHUN-CHIN TUNG, Chu Pei (TW); Yung-Lieh Chien, Chu Pei (TW)

Correspondence Address: G. LINK CO., LTD, 3550 BELL ROAD, MINOOKA, IL, 60447, US

(21) Appl. No.: 11/740,927

(22) Filed: Apr. 27, 2007

(30) Foreign Application Priority Data
May 4, 2006 (TW) 095115843

(51) Int. Cl. H01M 16/00; H01M 10/46

(52) U.S. Cl. 429/9; 320/101

(57) ABSTRACT

The present invention discloses a fuel cell capable of power management, including: a fuel cell power generator; an internal secondary battery; an internal load, which is a control member inside the fuel cell; an external load power-supply circuit, which converts electrical power generated by the fuel cell power generator into a specific output form and transmits the electrical power to an exterior of the fuel cell; and an internal load power-supply circuit, which converts electrical power into a specific output form and transmits the electrical power to the internal load of the fuel cell. Additionally, the internal load power-supply circuit further includes a selection means. By selecting the selection means, electrical power generated either by the fuel cell power generator or by the internal secondary battery is converted into a specific output form.

### FIELD OF THE INVENTION

The present invention relates to a fuel cell capable of power management, particularly to a fuel cell having an internal secondary battery for supplying electrical power required for internal load operations of the fuel cell.

### BACKGROUND OF THE INVENTION

Conventional fuel cells produce electrochemical reactions and generate electricity by combining hydrogen-rich fuels and oxygen-rich fuels. However, if conventional fuel cells have not been used for a long time, their membrane electrode assembly (MEA) becomes less humid for initiation. Therefore, for conventional fuel cells, their MEAs must be humidified, before the fuel cells achieve normal electrochemical reaction efficiency and rated output power. Hence, before conventional fuel cells have been completely initiated, electrical power is required for the internal load operations of a micro-processing unit and a fuel control unit in the fuel cell. Consequently, electrical power so required can be supplied either directly by the fuel cell for internal load operations or indirectly by an external secondary battery parallel connected to the fuel cell for internal load operations. However, conventional fuel cells are not provided with other secondary battery to supply electrical power required for their internal load operations. In other words, conventional fuel cells are unable to operate independently without an external secondary battery. To overcome this drawback, an external secondary battery is integrated into the fuel cell. Despite this improvement, this fuel cell system will become too huge in size, thereby affecting the portability and increasing the cost of the fuel cell.

To overcome the drawbacks of conventional fuel cells, the present invention provides a fuel cell capable of power management.

### SUMMARY OF THE INVENTION

Accordingly, an objective of the present invention is to provide a fuel cell capable of power management, such that the fuel cell includes an internal secondary battery for activating the initiation process of the fuel cell.

Alternatively, another objective of the invention is to provide a fuel cell capable of power management, such that the fuel cell includes an internal secondary battery, wherein a single, minimized secondary cell is used as the internal secondary battery in order to avoid an increase in the size and higher costs of the fuel cell, when electrical power generated by this single cell is sufficient for internal load operations.

Alternatively, another objective of the invention is to provide a fuel cell capable of power management, such that the fuel cell includes an internal secondary battery and a charger for charging the internal secondary battery under normal operations of the fuel cell, thereby achieving normal operations of the internal secondary battery.

Alternatively, another objective of the invention is to provide a fuel cell capable of power management, such that the fuel cell includes an external power source, which replaces the rated power output of the fuel cell power generator and the internal secondary battery, when the fuel cell is unable to operate normally and when electrical power generated by the internal secondary battery is not sufficient.

To achieve the above-mentioned objectives, the present invention discloses a fuel cell capable of power management. The fuel cell includes a fuel cell power generator; an internal secondary battery; an internal load, which is a control member inside the fuel cell; an external load power-supply circuit, which converts electrical power generated by the fuel cell power generator into a specific output form and then transmits the electrical power for the exterior of the fuel cell; and an internal load power-supply circuit, which converts electrical power into a specific output form and then transmits the electrical power for the internal load operations of the fuel cell. Additionally, the internal load power-supply circuit further includes a selection means. By selecting the selection means, electrical power generated either by the fuel cell power generator or by the internal secondary battery is converted into a specific output form.

According to a preferred embodiment of the present invention, the internal secondary battery is a smaller, rechargeable lithium or hydride-nickel or cadmium-nickel battery, supported by electrical power consumption required for internal load operations, wherein a single lithium cell is selected as an internal secondary battery to avoid an increase in the size and higher costs of the fuel cell.

According to another preferred embodiment of the present invention, the fuel cell further includes a charger, which selects either the charging state or the non-charging state of the internal secondary battery.

According to another preferred embodiment of the present invention, the fuel cell further includes an external power source, which is electrically connected to an alternating current (AC) and changes the AC electrical connection into a direct current (DC) electrical connection in order to replace the rated power output of the fuel cell power generator and the internal secondary battery.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an illustrative view of the relationship among members disclosed in an embodiment of the fuel cell capable of power management for the present invention;

FIG. 2 is an illustrative view of the relationship among circuit members disclosed in the embodiment of FIG. 1 for the present invention;

FIG. 3 is an illustrative view of the relationship among localized members disclosed in a second embodiment of the fuel cell capable of power management for the present invention;

FIG. 4 is an illustrative view of the relationship among localized members disclosed in a third embodiment of the fuel cell capable of power management for the present invention; and

FIG. 5 is an illustrative view of the relationship among localized members disclosed in a fourth embodiment of the fuel cell capable of power management for the present invention.

### DETAILED DESCRIPTION OF THE INVENTION

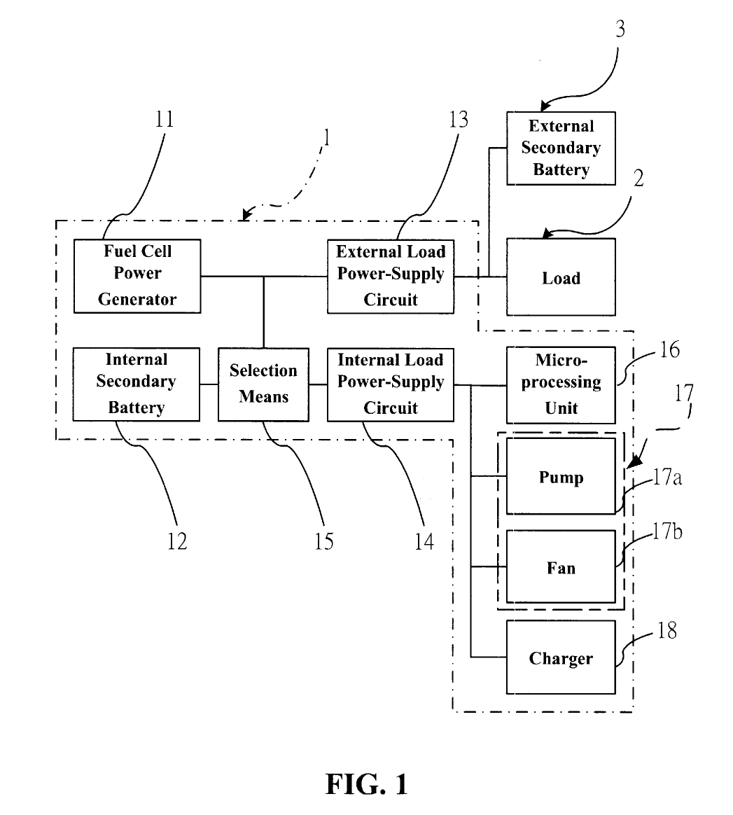

Referring to FIG. 1, the present invention discloses a fuel cell system (1) capable of power management, including a fuel cell power generator (11), an internal secondary battery (12), an external load power-supply circuit (13), an internal load power-supply circuit (14), a micro-processing unit (16), a fuel control unit (17) and a charger (18). The fuel cell power generator (11) contains a catalyst for producing electrochemical reactions by combining hydrogen-rich fuels and oxygen-rich fuels, thereby converting chemical energy into electrical energy. The internal secondary battery (12) is an energy carrier that outputs electrical power and provides charging, while the external load power-supply circuit (13) converts electrical power into a specific output form, such that the electrical power in the specific output form is transmitted to a load (2) outside the fuel cell system (1) for the operations of the load (2). The internal load power-supply circuit (14) converts electrical power into a specific output form, such that the electrical power in the specific output form is transmitted to a plurality of control members inside the fuel cell system (1) for the operations of the selected members. The micro-processing unit (16) having a logical judgment and control means processes electrical information of the fuel cell system (1) and controls internal members of the fuel cell system (1), by using the logical judgment and control means. The fuel cell control unit (17) is provided with a master to control the input of fuel required for electrochemical reactions of the fuel cell system (1), while the charger (18) supplies electrical power generated by the fuel cell power generator (11) to the internal secondary battery (12) for charging the internal secondary battery (12).

The internal load power-supply circuit (14) is further provided with a selection means (15). By selecting the selection means (15), electrical power is supplied either by the fuel cell power generator (11) or by the internal secondary battery (12) to the internal load power-supply circuit (14), and electrical power is transmitted to the plurality of control members, which are primarily the micro-processing unit (16), the fuel control unit (17) and the charger (18) in the fuel cell system (1). Additionally, the internal load power-supply circuit (14) decides whether electrical power is supplied to the charger (18), such that when the internal secondary battery (12) generates and outputs electrical power, the charger (18) will stop operations. For example, the charger (18) of the present invention is an electronic switch, which is a transistor switch or a MOS switch or other electronic switch. Therefore, by controlling electronic information and the operations of the internal secondary battery (12), the charger (18) is either opened or closed in order to decide whether the internal secondary battery (12) proceeds with charging.

The internal secondary battery (12) is a rechargeable lithium or hydride-nickel or cadmium-nickel battery. Additionally, based on the size of the fuel cell system (1) and the required electrical power consumption, a smaller, rechargeable lithium or hydride-nickel or cadmium-nickel battery or other rechargeable battery is selected as the internal secondary battery (12). For example, power consumption specification is selected for the internal secondary battery (12) based on the electrical power consumption required for the micro-processing unit (16) and the fuel control unit (17). Considering that the micro-processing unit (16) is 5V and the fuel control unit (17) is 12 V, a single 3.6V˜4.2V lithium cell is selected as the internal secondary battery (12). Therefore, by converting and transmitting electrical power of the internal load power-supply circuit (14), the electrical power is supplied to the micro-processing unit (16) and the fuel control unit (17).

Taking the direct methanol fuel cell (DMFC) as an example, the fuel control unit (17) includes a pump (17a) and a fan (17b). The pump (17a) inputs methanol fuel required for the anode of the fuel cell system (1) for electrochemical reactions, while the fan (17b) inputs oxygen fuel required for the cathode of the fuel cell system (1) for electrochemical reactions. Also, the fan (17b) can further act as a heat sink of the fuel cell system (1) for inputting lower-temperature air at the exterior of the fuel cell system (1) for heat exchange in order to achieve temperature control of the fuel cell system (1).

In the fuel cell system (1), the electrical power generated by the fuel cell power generator (11) is supplied to the load (2) by converting voltage of the external load power-supply circuit (13) and transmitting electrical power of the external load power-supply circuit (13). Additionally, the fuel cell system (1) can further be electrically, parallel connected to an external secondary battery (3). Therefore, when the electrical power generated by the fuel cell power generator (11) of the fuel cell system (1) is not sufficient, the external secondary battery can synchronously supply electrical power required for the operations of the load (2), wherein the external secondary battery (3) is a rechargeable lithium or hydride-nickel or cadmium-nickel battery or other rechargeable battery.

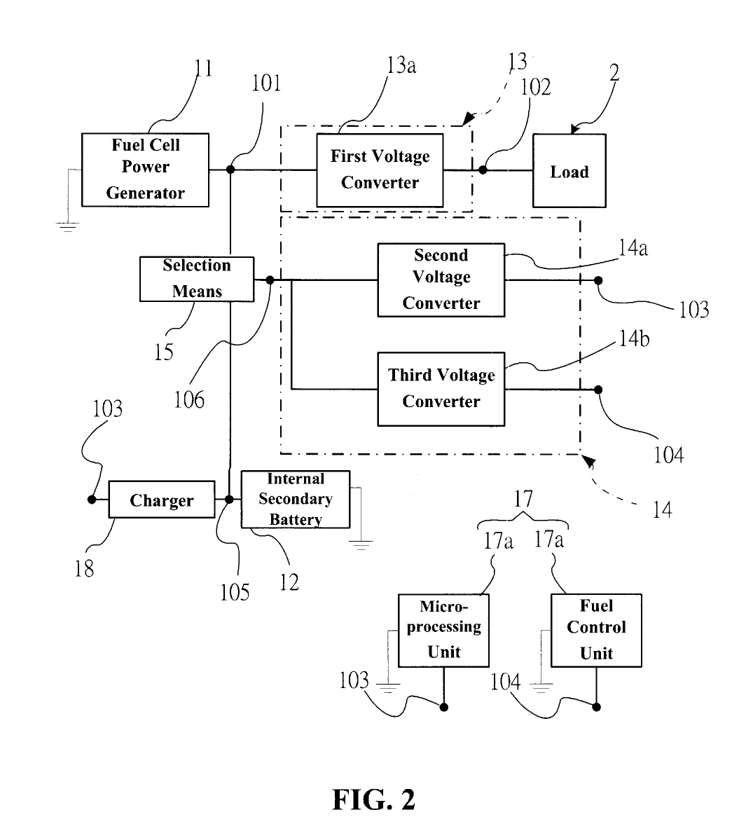

Referring to FIG. 2, the drawing defines a first electrical contact (101), a second electrical contact (102), a third electrical contact (103), a fourth electrical contact (104), a fifth electrical contact (105), and a sixth electrical contact (106), which are electrically connected to each corresponding member respectively. The fuel cell power generator (11) is electrically connected to the external load power-supply circuit (13) and the selection means (15) via the first electrical contact (101), while the external load power-supply circuit (13) is electrically connected to the load (2) via the second electrical contact (102). Then the internal load power-supply circuit (14) is electrically connected to the selection means (15) via the sixth electrical contact (106), electrically connected to the micro-processing unit (16) and an electrical connection of the charger (18) via the third electrical contact (103), and electrically connected to the fuel control unit (17) via the fourth electrical contact (104). Also, the internal secondary battery (12) is electrically connected to the selection means (15) and another electrical connection of the charger (18) via the fifth electrical contact (105).

The external load power-supply circuit (13) includes a first voltage converter (13a), while the internal load power-supply circuit (14) includes a second voltage converter (14a) and a third voltage converter (14b), such that the first voltage converter (13a), the second voltage converter (14a) and the third voltage converter (14b) respectively output a specific voltage power source via the second electrical contact (102), the third electrical contact (103) and the fourth electrical contact (104) respectively. Consequently, the external load power-supply circuit (13) outputs a specific voltage power source to the load (2) via the first voltage converter (13a), while the internal load power-supply circuit (14) outputs power sources respectively at VCC voltage and VBOP voltage to diverse internal members respectively via the second voltage converter (14a) and the third voltage converter (14b). Moreover, each of the first voltage converter (13a), the second voltage converter (14a) and the third voltage converter (14b) selects the BOOST circuit means or the BUCK circuit means or the SEPIC/ZELTA circuit means. The purpose of the BOOST circuit means is to boost the output voltage of the fuel cell, while the purpose of the BUCK circuit means is to lower the output voltage of the fuel cell. The SEPIC/ZELTA circuit means is to adjust the output voltage based on the size of the output voltage of the fuel cell, such that the output voltage becomes steady and constant. In other words, when the output voltage of the fuel cell is higher than the default output voltage, this circuit converts the input voltage into a lower default output voltage. On the contrary, when the output voltage of the fuel cell is lower than the default output voltage, this circuit converts the input voltage into a higher default output voltage.

When the fuel cell power generator (11) is not under operations or not under normal operations, by selecting the selection means (15), electrical power is supplied from the internal secondary battery (12) to the internal load power-supply circuit (14) before two specific voltage power sources are output respectively via the second voltage converter (14a) and the third voltage converter (14b) of the internal load power-supply circuit (14) in order to supply electrical power required for the operations of internal members. When the fuel cell power generator (11) is under normal operations, the fuel cell power generator (11) outputs a specific voltage to the external load (2) via the external load power-supply circuit (13). Additionally, the micro-processing unit (16) controls the selection means (15), such that the fuel cell power generator (11) supplies electrical power to the internal load power-supply circuit (14) and outputs two specific voltage power sources respectively via the second voltage converter (14a) and the third voltage converter (14b) of the internal load power-supply circuit (14) in order to supply electrical power required for the operations of internal members. It should be noted that when the fuel cell power generator (11) is not under operations or is not under normal operations, this usually means when activating the initialization process, the fuel cell power generator (11) supplies electrical power from the internal secondary battery (12) to the internal load power-supply circuit (14) based on the judgment made by the micro-processing unit (16) or based on the circuit means selected, until the fuel cell power generator (11) generates and supplies electrical power after activating the initiation process and achieving normal operations.

When the internal secondary battery (12) outputs electrical power to the internal load power-supply circuit (14), the charger (18) decides not to charge the internal secondary battery (12). However, when the fuel cell power generator (11) outputs electrical power to the internal load power-supply circuit (14), the charger (18) decides to charge the internal secondary battery (12) until the internal secondary battery (12) becomes charged.

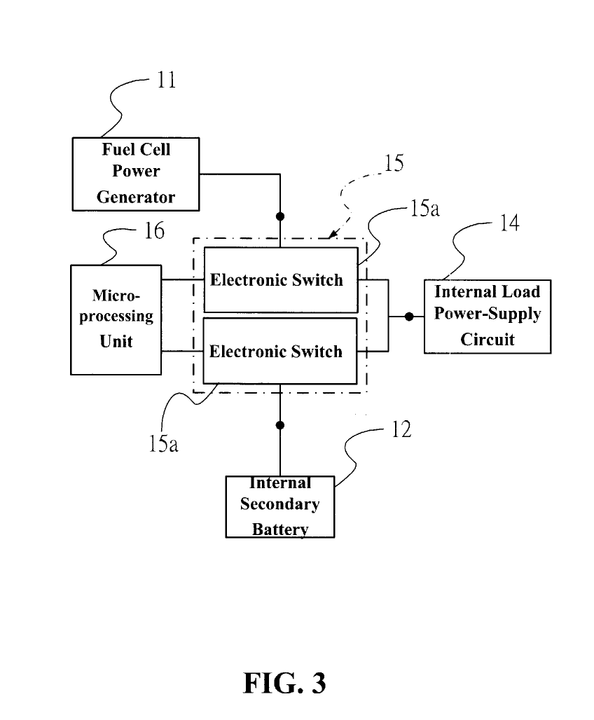

Referring to FIG. 3, the selection means (15) is formed from the circuit formed by circuit members. In other words, the selection means (15) is an electronic switch (15a) such as a MOS switch or a FET switch. These electronic switches (15a) are controlled by the micro-processing unit (16) in order to select either the fuel cell power generator (11) or the internal secondary battery (12) for outputting electrical power to the internal load power-supply circuit (14).

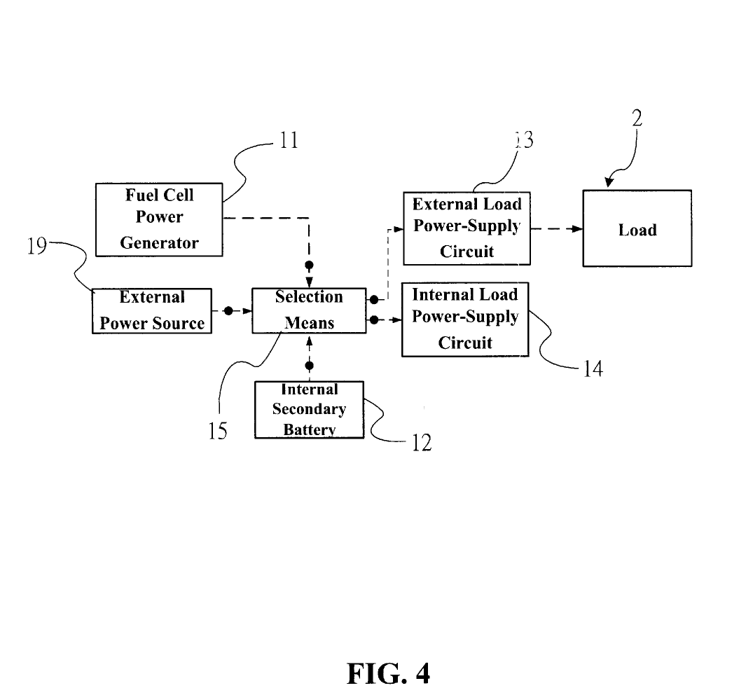

Referring to FIG. 4, the fuel cell capable of power management further includes an external power source (19), which is electrically connected to the AC power source and changes the AC electrical connection to a DC electrical connection in order to input the DC to the fuel cell system capable of power management. Also, the fuel cell power generator (11), the internal secondary battery (12) and the external power source (19) are respectively, electrically connected to the selection means (15), which is electrically connected to the external load power-supply circuit (13) and the internal load power-supply circuit (14). By using the selection means (15), the fuel cell power generator (11) or the internal secondary battery (12) or the external power supply (19) is selected, such that the electrical power so generated is distributed either to the external load power-supply circuit (13) or to the internal load power-supply circuit (14). Therefore, when the fuel cell power generator (11) is not under operations or not under normal operations and when the electrical power of the internal secondary battery (12) is not sufficient, by selecting the selection means (15), electrical power is supplied from the external power source (19) to the internal load power-supply circuit (14), before a specific voltage power source is output via the voltage converter of the internal load power-supply circuit (14) to supply electrical power required for the operations of internal members. Also, the external power source (19) outputs electrical power to the external load power-supply circuit (13) by selecting the selection means (15), in order to supply electrical power to the load (2) for the exterior of the fuel cell system (1) or to supply electrical power required for charging the external secondary battery (3) [See FIG. 1]. Moreover, the external power source (19) supplies electrical power to the charger (18) via the internal load power-supply circuit (14) [See FIG. 2] in order to charge the internal secondary battery (12).

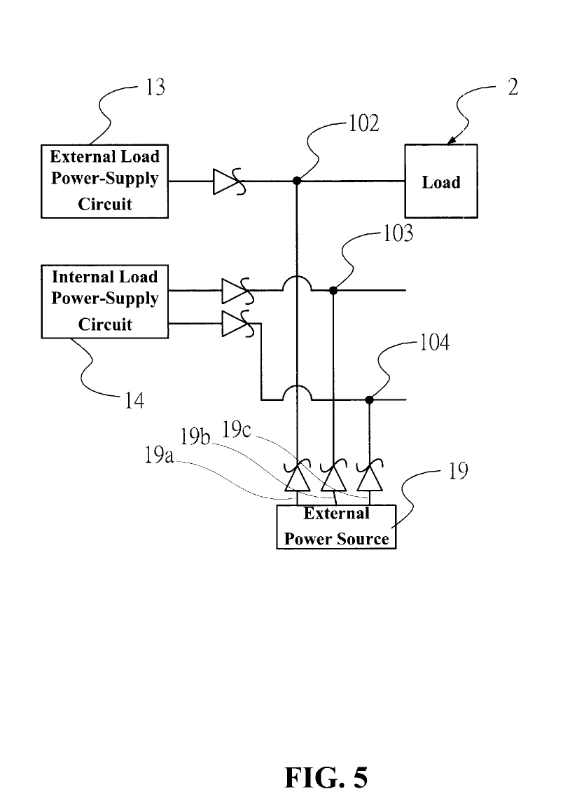

Referring to FIG. 5, the external power source (19) further including a first output port (19a), a second output port (19b) and a third output port (19c) is provided with circuits having diverse voltage conversion types, such that the first output port (19a), the second output (19b) and the third output port (19c) respectively output the voltage required for the load, VCC voltage and VBOP voltage respectively. Also, the first output port (19a), the second output port (19b) and the third output port (19c) are respectively, electrically connected to the second electrical contact (102), the third electrical contact (103) and the fourth electrical contact (104) [See FIG. 2], in order to output electrical power to the load (2), the micro-processing unit (16) and the fuel control unit (17) respectively. Moreover, the first output port (19a), the second output port (19b) and the third output port (19c) respectively restrict the flow of electric current, by series connecting the first output port (19a), the second output port (19b) and the third output port (19c) respectively to a diode. Under this restriction, electrical power generated by the first output port (19a), the second output port (19b) and the third output port (19c) is transmitted only to the second electrical contact (102), the third electrical contact (103) and the fourth electrical contact (104) respectively.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell capable of power management, comprising:
a fuel cell power generator;
an internal secondary battery;
an internal load, being a control member inside the fuel cell;
an external load power-supply circuit, for converting electrical power generated by the fuel cell power generator into a specific output form and for transmitting the electrical power to the exterior of the fuel cell; and
an internal load power-supply circuit, for converting electrical power into a specific output form and for transmitting the electrical power to the internal load of the fuel cell;
wherein the internal load power-supply circuit further comprises a selection means for selecting electrical power generated either by the fuel cell power generator or by the internal secondary battery is converted into a specific output form.

2. The fuel cell capable of power management as claimed in claim 1, wherein the internal secondary battery is a rechargeable lithium or hydride-nickel or cadmium-nickel battery.

3. The fuel cell capable of power management as claimed in claim 2, wherein a smaller, rechargeable battery is selected as the internal secondary battery, supported by electrical power consumption sufficient for the internal load.

4. The fuel cell capable of power management as claimed in claim 3, wherein the secondary battery is a single lithium cell.

5. The fuel cell capable of power management as claimed in claim 1, further comprising a micro-processing unit, having a logical judgment and control means for processing electrical information of the fuel cell and controlling members inside the fuel cell; and
the selection means further comprising an electronic switch;
wherein by using the logical judgment and control means, the micro-processing unit controls the electronic switch for the control means and transmits the electrical power generated either by the fuel cell power generator or by the internal secondary battery to the internal load power-supply circuit.

6. The fuel cell capable of power management as claimed in claim 5, wherein the electronic switch is either a transistor switch or a MOS switch.

7. The fuel cell capable of power management as claimed in claim 1, further comprising a charger for selecting either the charging state or the non-charging state of the internal secondary battery.

8. The fuel cell capable of power management as claimed in claim 7, further comprising a micro-processing unit, having a logical judgment and control means for processing electrical information of the fuel cell and controlling members inside the fuel cell; and
the charger further comprising an electronic switch;
wherein by using the logical judgment and control means, the micro-processing unit controls the electronic switch for the charger and selects either the charging state or the non-charging state of the internal secondary battery.

9. The fuel cell capable of power management as claimed in claim 8, wherein the electronic switch is either a transistor switch or a MOS switch.

10. The fuel cell capable of power management as claimed in claim 7, wherein the fuel cell power generator is electrically connected to the external load power-supply circuit and the selection means via a first electrical contact; the external load power-supply circuit is electrically connected to the load via a second electrical contact; the internal load power-supply circuit is electrically connected to the selection means via a third electrical contact, is electrically connected to the micro-processing unit and an electrical connection of the charger via a fourth electrical contact, and is electrically connected to the fuel control unit via a fifth electrical contact; and the secondary battery is electrically connected to the selection means and another electrical connection of the charger via a sixth electrical contact.

11. The fuel cell capable of power management as claimed in claim 10, wherein the external load power-supply circuit comprises a first voltage converter, such that the first voltage converter outputs a specific voltage power source; and
the internal load power-supply circuit comprising a second voltage converter and a third voltage converter, such that each of the second voltage converter and the third voltage converter outputs a specific voltage power source respectively.

12. The fuel cell capable of power management as claimed in claim 11, wherein the first voltage converter uses the BOOST circuit means or the BUCK circuit means or the SEPIC/ZELTA circuit means.

13. The fuel cell capable of power management as claimed in claim 11, wherein the second voltage converter uses the BOOST circuit means or the BUCK circuit means or the SEPIC/ZELTA circuit means.

14. The fuel cell capable of power management as claimed in claim 11, wherein the third voltage converter uses the BOOST circuit means or the BUCK circuit means or the SEPIC/ZELTA circuit means.

15. The fuel cell capable of power management as claimed in claim 1, wherein the internal load comprises a micro-processing unit, having a logical judgment and control means for processing electrical information of the fuel cell and controlling members inside the fuel cell.

16. The fuel cell capable of power management as claimed in claim 1, wherein the internal load comprises a fuel control unit for inputting fuel required for electrochemical reactions of the fuel cell.

17. The fuel cell capable of power management as claimed in claim 16, wherein the fuel control unit comprises a pump and a fan.

18. The fuel cell capable of power management as claimed in claim 1, wherein the fuel cell is electrically, parallel connected to an external secondary battery.

19. The fuel cell capable of power management as claimed in claim 1, further comprising an external power source, which is electrically connected to an alternating current (AC) and changes the AC electrical connection to a direct current (DC) electrical connection.

20. The fuel cell capable of power management as claimed in claim 19, wherein the external power source is electrically connected to the selection means, which selects the fuel cell power generator or the secondary battery or the external power source for generating and outputting electrical power to the internal load power-supply circuit.

21. The fuel cell capable of power management as claimed in claim 20, wherein the external power source is electrically connected to the selection means, which selects either the fuel cell power generator or the external power source for generating and outputting electrical power to the external load power-supply circuit.

22. The fuel cell capable of power management as claimed in claim 19, wherein the external power source further comprises a first output port, a second output port and a third output port, which respectively output electrical power at the voltage required for the load, the first voltage and the second voltage; and
the first output port, the second output port and the third output port are electrically connected to said second electrical contact, the fourth electrical contact and the fifth electrical contact respectively.

23. The fuel cell capable of power management as claimed in claim 1, wherein when the fuel cell power generator is not under normal operations, the internal secondary battery supplies electrical power to the internal load power-supply circuit, by selecting the selection means.

24. The fuel cell capable of power management as claimed in claim 23, wherein the internal secondary battery is a rechargeable lithium or hydride-nickel or cadmium-nickel battery.

25. The fuel cell capable of power management as claimed in claim 24, wherein a smaller, rechargeable battery is selected as the internal secondary battery, supported by electrical power consumption required for the internal load.

26. The fuel cell capable of power management as claimed in claim 25, wherein the secondary battery is a single lithium cell.

27. The fuel cell capable of power management as claimed in claim 26, further comprising a charger, which selects either the charging state or the non-charging state of the internal secondary battery.

28. The fuel cell capable of power management as claimed in claim 26, wherein the external power source is electrically connected to the selection means; the fuel cell power generator or the secondary battery or the external power source generates and outputs electrical power either to the internal load power-supply circuit or to the external load power-supply circuit, by selecting the selection means.
